(19) United States
(12) Patent Application Publication
(10) Pub. No.: US 2011/0271191 A1
(43) Pub. Date: Nov. 3, 2011

(54) Providing An Indication Of Change At A User Interface Device Over A Network Between Computers

(76) Inventor: James M. King, Fort Collins, CO (US)

(21) Appl. No.: 13/142,653

(22) PCT Filed: Jan. 29, 2009
(86) PCT No.: PCT/US09/32373

§ 371 Date: Jun. 29, 2011

(51) Int. Cl. G06F 3/01; G06F 15/16

(52) U.S. Cl. 715/719; 715/733

(57) ABSTRACT

A first computer receives data of a user interface device over a network from a second computer, wherein the data of the user interface device is received in response to a change occurring at the user interface device. In response to a request from a requesting entity in the first computer, a module in the first computer determines whether the data of the user interface device has been received by the first computer. In response to determining that the data of the user interface device has been received, the module provides the received data to the requesting entity in response to the request, and in response to determining that the data of the user interface device has not been received, the module provides an indication to the requesting entity that no change has occurred at the user interface device.

### BACKGROUND

Many enterprises are transitioning to a network arrangement in which computing resources of central servers are provided to local computers at which users are located. The computing resources (e.g., software applications, processing resources, storage resources, etc.) that are centralized at one or more central servers can be selectively allocated to a session established by a user at a local computer.

Protocols are provided to enable a user at a local computer to access and share the desktop of a remote computer (e.g., a central server) over a computer network. One such protocol is the Remote Desktop Protocol (RDP), as provided by Microsoft Corporation, to provide remote display and input capabilities over network connections. Another protocol that can be used is the Remote Graphics Software (RGS) protocol from the Hewlett Packard Co. RGS is designed to take full advantage of the computer and graphics resources of a remote computer to deliver interactive remote access at the local computer. The desktop video data of the remote computer is transmitted over the network to the local computer, which displays the desktop video data locally in a window at the local computer. RGS is designed to provide fast capture, compression, and transmission of a desktop video data over a network. RGS also allows audio data to be sent from the remote computer to the local computer for output on an audio device of the local computer. RGS also captures user keyboard and mouse inputs at the local computer, and sends the keyboard and mouse inputs to the remote computer for processing by the operating system of the remote computer, and by applications running on the remote computer.

The keyboard and mouse (and/or other peripheral devices) attached to the local computer can be human interface devices (HIDs) that operate according to the HID standard, as described in Universal Serial Bus (USB), Device Class Definition For Human Interface Devices (HID), Firmware Specification, Version 1.11, dated Jun. 27, 2001. An HID device is an interrupt-type device that generates data to transfer on a continual basis. The transfer of data occurs even if there is no data to transfer, with the HID device sending null or zero HID data if no change has occurred at the HID device.

In the context of an arrangement in which the HID device is attached to a local computer that accesses resources of a remote computer over a network, the remote computer has a device driver that typically schedules intervals during which the HID device transfers HID data from the local computer to the remote computer over the network. The device driver of the remote computer, in each interval, sends a request to the local computer for the HID data of the HID device. In response to such device driver requests, the local computer will send HID data back to the remote computer over the network, even if no change has occurred at the HID device. If no change has occurred at the HID device when data is requested by the remote computer, the local computer will send zero HID data over the network to the remote computer.

The sending of zero HID data and the periodic requests sent by the remote computer to the local computer consume valuable network resources. In a system that may have many local computers and many remote computers, the traffic described above can cause congestion in a network.

### BRIEF DESCRIPTION OF THE DRAWINGS

Some embodiments of the invention are described, by way of example, with respect to the following figures:

FIG. 1 is a block diagram of an exemplary arrangement that includes a local computer and remote computer, in which an embodiment of the invention can be incorporated;

FIG. 2 is a flow diagram of a process performed at a local computer (receiving system) of communicating an indication of change at a user interface device (attached to the local computer) to the remote computer, in accordance with an embodiment; and

FIG. 3 is a flow diagram of a process performed at a remote computer (sending system) of responding to a request from a device driver at the remote computer for data relating to the user interface device attached to the local computer, in accordance with an embodiment.

### DETAILED DESCRIPTION

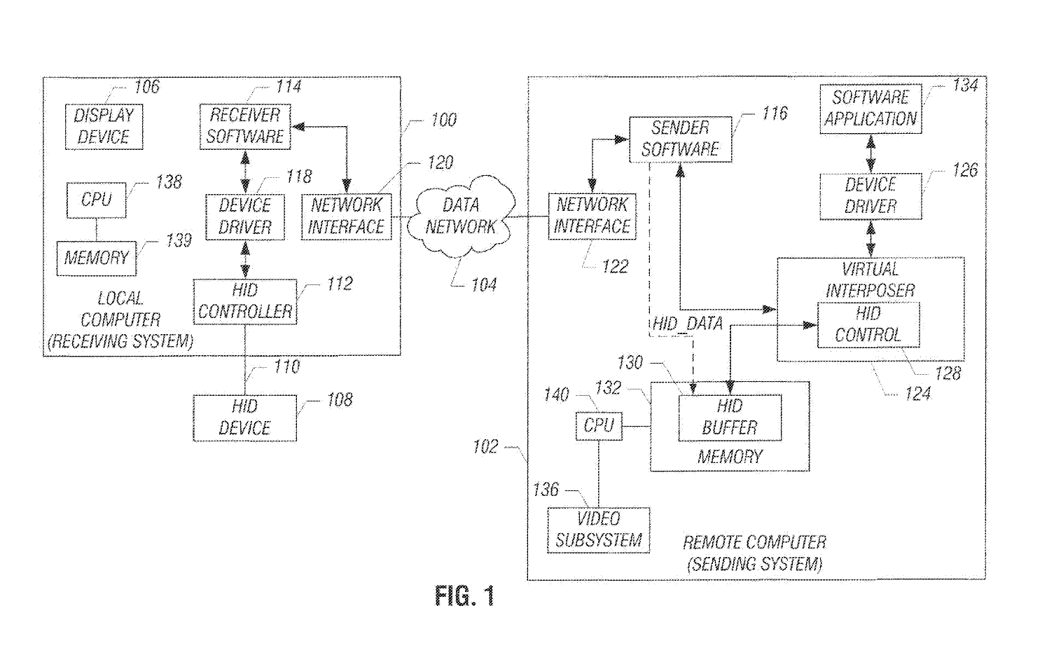

FIG. 1 illustrates an arrangement in which a local computer 100 (at which a user is located) is connected to a remote computer 102 over a data network 104. Although just one local computer 100 and one remote computer 102 is depicted in FIG. 1, it is noted that there can be multiple local computers 100 and/or multiple remote computers 102.

The local computer 100 uses the resources of the remote computer 102 in sessions established between the local computer 100 and the remote computer 102. For example, the local computer 100 can use the graphics resources of the remote computer 102, in which the remote computer 102 delivers desktop video data of the remote computer over the network 104 to the local computer 100 for display in a display device 106 of the local computer 100.

Also, one or more user interface devices 108 are attached to the local computer 100. Changes in the state of the user interface device 108 are communicated from the local computer 100 over the data network 104 to the remote computer 102. In some embodiments, the user interface device 108 is a human interface device (HID) according to the HID standard, as described in Universal Serial Bus (USB), Device Class Definition For Human Interface Devices (HID), Firmware Specification, Version 1.11, dated Jun. 27, 2001. In other embodiments, the user interface device 108 can operate according to other standards. In the ensuing discussion, reference is made to an “HID device” attached, to the local computer 100. However, it is noted that techniques according to some embodiments can be applied to other types of user interface devices.

A mechanism according to some embodiments is provided to allow for efficient transfer of data relating to the HID device 108 to the remote computer 102. This mechanism avoids the transmission of zero or null HID data (where zero or null HID data refers to data indicating that the HID device 108 has not changed, in other words, a user has not moved or actuated the HID device 108). Also, in accordance with some embodiments, the remote computer 102 does not send requests over the data network 104 to the local computer 100 to request updates of the HID device 108.

Instead, for improved efficiency, the local computer 100 sends HID data over the data network 104 to the remote computer 102 only if there has been a change at the HID device 108 (e.g., a user has moved a mouse, actuated a keyboard, moved a roller ball-type input device, moved an input device on a tablet, etc.). In this manner, more efficient usage of the data network 104 is achieved for the communication of data relating to the HID device 108, since requests for data relating to HID device 108 and zero HID data do not have to be transferred over the network 104.

The data network 104 can communicate data according to the Internet Protocol (IP). The HID device 108 can be attached to the local computer 100 over a Universal Serial Bus (USB) link 110 (wired or wireless USB link) to the local computer 100. More specifically, the HID device 108 is connected over the USB link 110 to an HID controller 112. In the above-described implementation, any data relating to the HID device 108 is in the form of USB data that is communicated in IP packets transferred over the data network 104 to the remote computer 102. Although reference is made to “USB” and “IP” in the embodiments described, it is noted that techniques according to some embodiments can be applicable to data packets according to other types of protocols.

The local computer 100 is referred to as a “receiving system,” and the remote computer 102 is referred to as a “sending system.” As such, the local computer 100 includes receiver software 114, and the remote computer 102 includes sender software 116. The sender software 116 is used for sending desktop video data of the remote computer 102 (sending system) over the data network 104 to the receiver software 114 in the local computer 100 (receiving system), where the desktop video data is displayed at the display device 106. Note that the desktop video data and audio data sent by the sender software 116 is actual rendering video data and rendering audio data that can be rendered by a respective display device and audio output device. The rendering video data and rendering audio data are different from data contained in source video files (e.g., MPEG files) or source audio files that have to be converted to a format that can be rendered by respective output devices.

The sender software 116 in the remote computer 102 receives video data from a video subsystem 136 in the remote computer 102. The video data of the video subsystem 136 is displayable by a display device attached to the remote computer 102. The sender software 116 then applies compression to the video data that is sent to the receiver software 114, which can then perform decompression of the video data before displaying the video data at the display device 106. Note that an actual display device does not have to be connected to the video subsystem 136 of the remote computer 102 in some implementations; however, in other implementations, a display device can be connected to the remote computer 102.

In some embodiments, the sender software 116 and receiver software 114 are according to the Remote Graphics Software (RGS) protocol from the Hewlett-Packard Co. RGS is designed to take full advantage of computer and graphics resources of a remote computer to deliver interactive remote access from a local computer. In a different embodiment, the sender software 116 and receiver software 114 can operate according to the Remote Desktop Protocol (RDP) from Microsoft Corporation, to provide remote display and input capabilities over network connections. In further embodiments, the sender software 116 and receiver software 114 can be according to other technologies.

A device driver 118 in the local computer 100 continually monitors the HID controller 112 to receive information regarding the HID device 108. In accordance with some embodiments, the device driver 118 does not send any data over the data network 104 if there has been no change to the HID device 108 (in other words, the device driver 118 does not cause zero HID data to be sent over the data network 104). However, if the device driver 118 detects a change at the HID device 108, such as due to user manipulation of the HID device 108, the device driver 118 sends the updated HID data to the receiver software 114, which in turn sends the HID data (in the form of USB data) to a network interface 120 in the computer 100.

The network interface 120 includes a physical network interface controller as well as a protocol stack, including an IP protocol stack. The network interface 120 sends the USB HID data in one or more IP packets over the data network 104 to the remote computer 102. The IP packets are received by a network interface 122 in the remote computer 102, which extracts the USB HID data from the IP packets and forwards the USB HID data to the sender software 116. The sender software 116 in turn sends the USB HID data to an HID data buffer 130 that is part of a memory 132 in the remote computer 102.

In accordance with some embodiments, if the RID data buffer 130 contains HID data, then that is an indication that a change has occurred at the HID device 108. On the other hand, if the HID data buffer 130 is empty, then that is an indication that no change has occurred at the HID device 108.

The remote computer 102 also includes a device driver 126 for the HID device 108, which issues requests (e.g., at intermittent intervals) for updated data regarding the HID device 108 (such as to check whether a mouse or other peripheral device has been moved). The remote computer 102 also includes a virtual interposer 124, which intercepts calls from a device driver 126 in the remote computer 102 that is intended for the HID device 108 that is attached to the local computer 100 rather than the remote computer 102. The virtual interposer 124 prevents calls to the HID device 108 from reaching lower level (kernel) device drivers of the operating system in the remote computer 102. Although not shown, other device drivers in the remote computer 102 can create audio data and video data that are provided to an audio subsystem (not shown) and video subsystem 136, respectively, to be rendered by respective output devices, such as respective output devices connected to the remote computer 100 and the remote computer 102.

In accordance with some embodiments, in response to calls from the device driver 126 for information regarding the HID device 108, an HID control module 128 in the virtual interposer 124 checks the HID buffer 130 in the memory 132 to determine if there is any data relating to the HID device 108. If there is no data in the HID buffer 130, then the HID control module 128 returns a response to the device driver 126 and contains zero HID data. On the other hand, if there is HID data in the buffer 130, then the HID control module 128 sends the actual HID data to the device driver 126.

Note that according to some embodiments, the virtual interposer 124 does not cause a call from the device driver 126 to be sent over the data network 101 to the local computer 100. Instead, the virtual interposer 124, and more specifically, the HID control module 128, handles responses to the calls from the device driver 126 locally.

The remote computer 102 also includes a software application 134. The software application 131 may have caused the device driver 126 to make a call to request updated information from the HID device 108. For example, the software application 134 may have presented a graphical user interface (GUI) for display to a user, where the GUI is capable of accepting user inputs in control menus, icons, and so forth. The video data relating to the GUI is stored in the video subsystem 136 of the remote computer 102. The video data in the video subsystem 136 is compressed by the sender software 116 for transmission over the data network 104, and the compressed video data is received by the receiver software 114 in the local computer 100, which decompresses the received video data and causes the video data to be displayed at the display device 106 of the local computer 100. In turn, a user who is viewing the GUI in the display device 106 may wish to use the HID device 108 to activate certain commands or to input information into the GUI. Manipulation of the HID device 108 is detected by the device driver 118, which causes the updated HID data (USB data in IP packets) to be sent by the receiver software 114 over the data network 104 to the sender software 116 of the remote computer 102. The updated HID data is stored by the sender software 116 in the HID buffer 130 in the memory 132.

The local computer 100 includes one or more central processing units (CPUs) 138, which is connected to memory 139. The software modules of the local computer 100, such as the receiver software 114 and device driver 118, are executable on the CPU(s) 138.

The remote computer 102 similarly includes one or more CPUs 140. The software modules of the remote computer 102, such as the software application 134, device driver 126, virtual interposer 124, and sender software 116 are executable on the CPU(s) 140.

Note that there can be multiple HID devices (or other types of user interface devices) attached to the local computer 100. In this case, there can be multiple corresponding device drivers 118 in the local computer 100 and multiple device drivers 126 and respective HID data buffers 130 in the remote computer 102, arranged to perform similar tasks as described above.

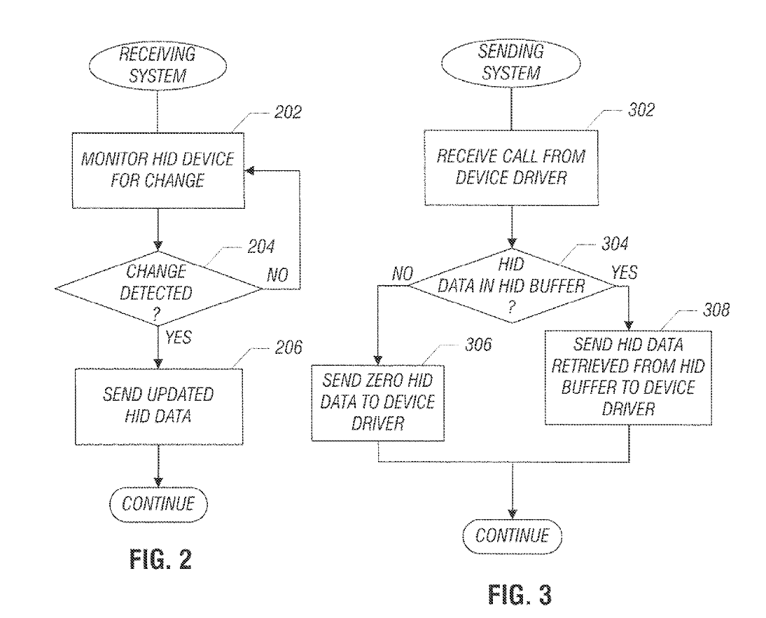

FIG. 2 shows a procedure according to an embodiment performed at the receiving system (local computer 100). The device driver 118 in the local computer 100 monitors (at 202) the HID device 108 for a change in the HID device 108. If a change is not detected (at 204), the device driver 118 returns to task 202 to continue to monitor for a change in the RID device 108. The device driver 118 does not cause zero HID data to be sent over the data network 104 if there is no change in the HID device 108.

However, if a change at the HID device 108 is detected, the device driver 118 sends (at 206) the updated HID data to the receiver software 114, which in turn sends the updated HID data to the network interface 120 for transmission in IP packets over the data network 104 to the remote computer 102.

FIG. 3 shows a procedure performed in the sending system (remote computer 102), and more specifically, by the HID control module 128 in the virtual interposer 124. The HID control module 128 receives (at 302) a call from the device driver for an update on the HID device 108. In response, the HID control module 128 checks (at 304) to determine if there is HID data in the HID buffer 130. If not, then the HID control module 128 sends zero HID data to the device driver 126. However, if there is HID data in the HID buffer 130, the HID control module 128 sends (at 308) HID data retrieved from the HID buffer 130 to the device 126.

Using techniques and mechanisms according to sonic embodiments, more efficient usage of network bandwidth is achieved for transfer of HID data over a data network.

Instructions of software described above (including the device drivers 118, 126, virtual interposer 124, HID control module 128, receiver software 114, and sender software 116 of FIG. 1) are loaded for execution on a processor (such as one or more CPUs 138, 140 in FIG. 1). The processor includes microprocessors, microcontrollers, processor modules or subsystems (including one or more microprocessors or microcontrollers), or other control or computing devices. A “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
a first computer receiving data of a user interface device over a network from a second computer, wherein the data of the user interface device is received in response to a change occurring at the user interface device; and
in response to a request from a requesting entity in the first computer:
determining, by a module in the first computer, whether the data of the user interface device has been received by the first computer;
in response to determining that the data of the user interface device has been received, the module providing the received data to the requesting entity in response to the request; and
in response to determining that the data of the user interface device has not been received, the module providing an indication to the requesting entity that no change has occurred at the user interface device.

2. The method of claim 1, further comprising:
the requesting entity submitting requests for a state of the user interface device at plural intermittent intervals; and
the module responding to each of the requests by:
determining whether the first computer has received updated data of the user interface device;
providing the updated data to the requesting entity if the updated data is received; and
providing the indication of no change at the user interface device if the updated data has not been received.

3. The method of claim 1, wherein receiving the data of the user interface device occurs without the first computer sending any request to the second computer for the data.

4. The method of claim 1, wherein providing the indication of no change at the user interface device comprises providing zero human interface device (HID) data.

5. The method of claim 1, further comprising:
storing the received data in a buffer of the first computer,
wherein determining whether the data of the user interface device has been received comprises accessing the buffer to check whether the buffer contains the received data.

6. The method of claim 1, wherein the request is received from a device driver in the first computer.

7. The method of claim 1, wherein receiving the data of the user interface device comprises receiving Universal Serial Bus (USB) data.

8. The method of claim 7, wherein receiving the data of the user interface device comprises receiving USB human interface device (HID) data.

9. The method of claim 7, wherein receiving the USB data comprises receiving the USB data over an Internet Protocol (IP) network.

10. The method of claim 7, further comprising:
the first computer sending video data in a video subsystem of the first computer over the network to the second computer for display at a display device at the second computer.

11. A first computer comprising:
a video subsystem;
a processor to:
send video data of the video subsystem over a network to a second computer for display at a display device of the second computer;
receive data of a user interface device attached to the second computer over the network;
in response to a request from a requesting entity in the first computer:
determine whether the data of the user interface device has been received by the first computer;
in response to determining that the data of the user interface device has been received, provide the received data to the requesting entity in response to the request; and
in response to determining that the data of the user interface device has not been received, provide an indication to the requesting entity that no change has occurred at the user interface device.

12. The first computer of claim 11, the determining task and providing tasks are performed by a virtual interposer executable on the processor.

13. The first computer of claim 11, wherein the data of the user interface device comprises data of a human interface device (HID).

14. An article comprising at least one computer-readable storage medium containing instructions that when executed cause a first computer to:
receive, over a network, data of a user interface device attached to a second computer;
in response to a request from a requesting entity in the first computer:
determine whether the data of the user interface device has been received by the first computer;
in response to determining that the data of the user interface device has been received, provide the received data to the requesting entity in response to the request; and
in response to determining that the data of the user interface device has not been received, provide an indication to the requesting entity that no change has occurred at the user interface device.

15. The article of claim 14, wherein the instructions when executed cause the first computer to further:
send video data of a video subsystem in the first computer over the network to a second computer for display at a display device of the second computer.
